(19) United States
(12) Patent Application Publication
(10) Pub. No.: US 2016/0059775 A1
(43) Pub. Date: Mar. 3, 2016

(54) METHODS AND APPARATUS FOR PROVIDING DIRECTION CUES TO A DRIVER

(71) Applicant: NUANCE COMMUNICATIONS, INC., Burlington, MA (US)

(72) Inventors: Nicolas Gorse, Montreal (CA); Jacek Spiewla, Novi, MI (US); William F. Ganong, Brookline, MA (US)

(73) Assignee: NUANCE COMMUNICATIONS, INC., Burlington, MA (US)

(21) Appl. No.: 14/474,641

(22) Filed: Sep. 2, 2014

(51) Int. Cl. B60Q 1/34; G01C 21/36; G01S 19/13; H04R 5/02

(52) U.S. Cl. CPC B60Q 1/346; H04R 5/02; G01C 21/36; G01S 19/13; H04R 2499/13

(57) ABSTRACT

Methods and apparatus for generating, for a GPS system-directed route, a visual cue signal to activate a visual indicator at a location in a vehicle passenger compartment corresponding to a direction of an upcoming event in the route and generating an audio signal to activate a sound source at a location in the vehicle passenger compartment corresponding to the direction of the upcoming event for providing spatial information to a user. In one embodiment, a validation signal can be generated to activate a confirmation indicator upon receiving information that the user has navigated the event in accordance with the route.

### BACKGROUND

As is known in the art, a significant percentage of people have difficulty in determining left and right directions. About fifteen percent of the North American population experiences difficulties in distinguishing between the directions left and right, which is a condition known as “left-right confusion.” People experiencing left-right confusion usually need a moment in order to determine a left/right direction. In GPS systems for vehicle navigation, this can present problems when a driver is instructed to “turn left,” for example. Delay and confusion by the driver can result in vehicle accidents and the like.

### SUMMARY

Embodiments of the invention provide a way to mitigate the difficulty some people have distinguishing between left and right directions. In embodiments, a GPS system provides functionality to enhance GPS visual and audio signals to take advantage of the lateral stimulus-response compatibility and/or monitor driver response to instructions. If the driver does not follow an instruction, the system can react and inform the driver that an action is inconsistent with following the route.

In one aspect of the invention, a method comprises: generating, for a GPS system-directed route, a visual cue signal to activate a visual indicator at a location in a vehicle passenger compartment corresponding to a direction of an upcoming event in the route; and generating an audio signal to activate a sound source at a location in the vehicle passenger compartment corresponding to the direction of the upcoming event for providing spatial information to a user.

The method can further include one or more of the following features: generating a validation signal to activate a confirmation indicator upon receiving information that the user has navigated the event in accordance with the route, the GPS system is configured for a vehicle and for providing route instructions to the user driving the vehicle, the visual indicator comprises an arrow, the visual cue signal is adapted to activate the visual indicator located on a left side of the vehicle passenger compartment when the upcoming event comprises a left turn, the audio signal is adapted to activate the audio source on a left side of the vehicle passenger compartment when the upcoming event comprises a left turn, the audio source comprises a loudspeaker and the audio signal comprises a signal to generate a particular sound from the loudspeaker, the audio signal comprises a spoken instruction to turn left and the loudspeaker is located on a left side of the vehicle passenger compartment, the validation signal is adapted to activate the confirmation indicator located on a left side of the vehicle passenger compartment when the upcoming event comprises a left turn, the validation signal is adapted to activate a visual display, the validation signal is adapted to activate a sound generator, and/or generating a warning signal if the event is not navigated in accordance with the route.

In another aspect of the invention, an article comprises: a non-transitory computer-readable medium having stored instructions that enable a machine to: generate, for a GPS system-directed route, a visual cue signal to activate a visual indicator at a location in a vehicle passenger compartment corresponding to a direction of an upcoming event in the route; and generate an audio signal to activate a sound source at a location in the vehicle passenger compartment corresponding to the direction of the upcoming event for providing spatial information to a user.

The article can further include one or more of the following features: generating a validation signal to activate a confirmation indicator upon receiving information that the user has navigated the event in accordance with the route, the GPS system is configured for a vehicle and for providing route instructions to the user driving the vehicle, the visual indicator comprises an arrow, the visual cue signal is adapted to activate the visual indicator located on a left side of the vehicle passenger compartment when the upcoming event comprises a left turn, the audio signal is adapted to activate the audio source on a left side of the vehicle passenger compartment when the upcoming event comprises a left turn, the audio source comprises a loudspeaker and the audio signal comprises a signal to generate a particular sound from the loudspeaker, the audio signal comprises a spoken instruction to turn left and the loudspeaker is located on a left side of the vehicle passenger compartment, the validation signal is adapted to activate the confirmation indicator located on a left side of the vehicle passenger compartment when the upcoming event comprises a left turn, the validation signal is adapted to activate a visual display, the validation signal is adapted to activate a sound generator, and/or generating a warning signal if the event is not navigated in accordance with the route.

In a further aspect of the invention, a system comprises: a memory and a processor configured to: generate, for a GPS system-directed route, a visual cue signal to activate a visual indicator at a location in a vehicle passenger compartment corresponding to a direction of an upcoming event in the route; and generate an audio signal to activate a sound source at a location in the vehicle passenger compartment corresponding to the direction of the upcoming event for providing spatial information to a user.

The system can further include the processor configured to provide one or more of the following features: generate a validation signal to activate a confirmation indicator upon receiving information that the user has navigated the event in accordance with the route, the GPS system is configured for a vehicle and for providing route instructions to the user driving the vehicle, the visual indicator comprises an arrow, the visual cue signal is adapted to activate the visual indicator located on a left side of the vehicle passenger compartment when the upcoming event comprises a left turn, the audio signal is adapted to activate the audio source on a left side of the vehicle passenger compartment when the upcoming event comprises a left turn, the audio source comprises a loudspeaker and the audio signal comprises a signal to generate a particular sound from the loudspeaker, the audio signal comprises a spoken instruction to turn left and the loudspeaker is located on a left side of the vehicle passenger compartment, the validation signal is adapted to activate the confirmation indicator located on a left side of the vehicle passenger compartment when the upcoming event comprises a left turn, the validation signal is adapted to activate a visual display, the validation signal is adapted to activate a sound generator, and/or generate a warning signal if the event is not navigated in accordance with the route.

### BRIEF DESCRIPTION OF THE DRAWINGS

The foregoing features of this invention, as well as the invention itself, may be more fully understood from the following description of the drawings in which:

FIG. 1 is a schematic representation of a navigation system to provide direction cues;

FIG. 2 is a schematic representation showing further information for a GPS system to provide direction cues;

FIG. 3 is a flow diagram to show a sequence of steps for generating directional cues;

FIG. 4 is a schematic representation of a driver attentiveness monitoring system;

FIG. 4A is a schematic representation showing further detail of a driver attentiveness monitoring system;

FIG. 5 is a flow diagram of driver attentiveness processing;

FIG. 6 is a schematic representation of a driver low distraction system;

FIG. 7 is a flow diagram of driver low distraction processing;

FIG. 8 is a schematic representation of a roadway sign and hazard monitoring system; and

FIG. 9 is a schematic representation of an illustrative computer that can perform at least a portion of the processing described herein.

### DETAILED DESCRIPTION

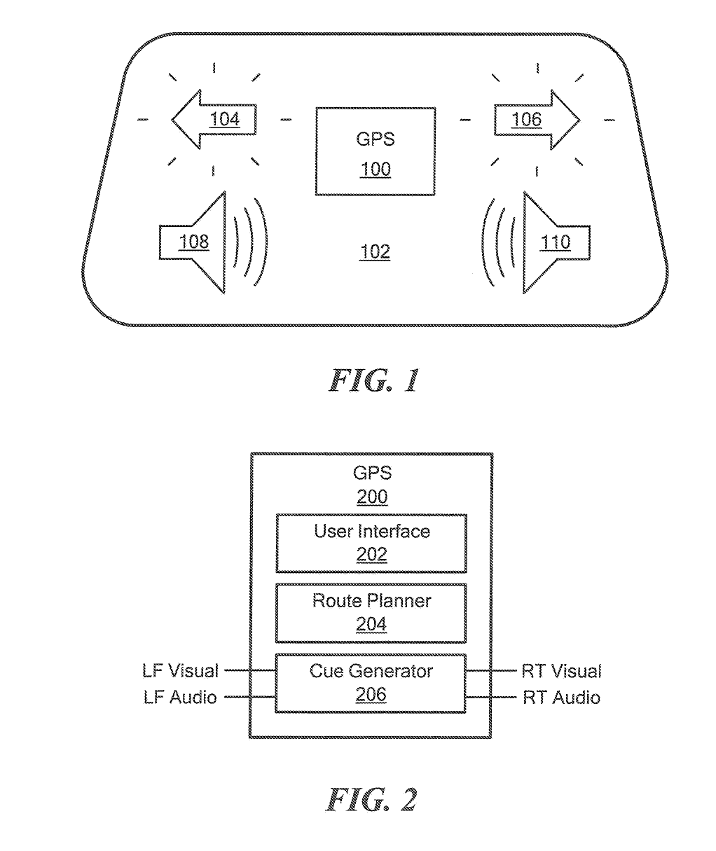

FIG. 1 shows a GPS (global positioning satellite) system 100 than can generate a route to a destination input by the user and provide turn-by-turn instructions to the driver of a vehicle to reach the destination. The GPS system 100 can be temporarily or permanently installed in cabin 102 of the vehicle, such as within the driver's field of view.

In one embodiment, the GPS system 100 is coupled to a left visual indicator 104 and a right visual indicator 106. In one particular embodiment, the visual indicators 104, 106 can be provided on a screen of the GPS. In another embodiment, the visual indicators 104, 106 corresponding to left/right blinkers or flashers of the vehicle. The left visual indicator 104 can have an arrow shape pointing to the left from the driver's perspective. Similarly, the right visual indicator 106 can include a right arrow. The GPS system can activate, e.g., illuminate, the left arrow some period of time prior to a left turn in the route plan. For example, at the time the GPS generates an audio message of “left turn ahead in 200 yards,” the left visual indicator 104 can be illuminated.

In an embodiment, the GPS system 100 is coupled to a left audio source 108 and a right audio source 110. The left and right audio sources 108, 110 can be provided as loudspeakers, for example. The left speaker 108 can be activated for left turn instructions and the right speaker 110 can be activated for right turn instructions to provide spatial information to the driver.

In embodiments, the visual indicators 104, 106 and audio indicators 108, 110 can be controlled by the GPS system to provide additional information to the driver. In one embodiment, the left visual indicator 104 can be activated in a way to control the intensity corresponding to the distance from the location of the left turn. In one embodiment, the GPS system can briefly activate the left visual indicator 104 at a time corresponding to the audio instruction. The left visual indicator 104 can then blink in increasing intensity until the turn location. Similarly, the left speaker 108 can generate the left turn instruction and emit a sound or series of sounds to provide ongoing directional information to the driver.

It is understood that the visual and audio indicators can form part of standard equipment in a vehicle or can be components of a portable GPS system. For a system embedded into a vehicle, the left visual indicator 104 can correspond to a left blinker in the car. It will be appreciated that the left blinker provides a visual clue to the driver, as well as to the drivers of vehicles behind the driver with the GPS system 100.

FIG. 2 shows a GPS system 200 having a user interface 202 coupled to a route planner 204 to enable a user to input destination information after which the GPS system provides a route to the destination. The GPS system 200 further includes a cue generator module 206 to provide visual and/or audio (spatial) information corresponding to the direction of an instruction to the driver. For example, the cue generator 206 can provide the control signals for the left and right visual indicators 104, 106 and left and right audio sources 108, 110 of FIG. 1.

In other embodiments, a variety of route-related information can be provided by the visual and/or spatial indicators. For example, a point of interest on the route can be announced using the speaker on the side of the point of interest itself, e.g. “Starbucks is coming up on the right” is generated spoken on the right speaker(s).

In one embodiment, the visual/audio indicators can provide user validation of a turn in accordance with the route and/or an indication that a turn was not executed in accordance with a turn instruction. For example, a validating flash signal for the right arrow can be generated during or after a right turn in the route. For a departure from the route, audio signals can be generated to inform the user of the deviation. For example, the driver can receive an audible warning and a repeat of the turn instruction if it appears that the user is not following the turn instruction. In embodiments, the warning volume and/or tone can be varied depending upon the situation.

In general, the driver response can be monitored in a variety of ways. For example, if a driver activates a directional signal for the vehicle, this can be monitored by an integrated GPS system. That is, the feedback can be obtained from the GPS. As the latter is gathering information about the current position, it is possible to determine whether the car is making a left, or a right, turn, for example, which can be used to validate the driver is turning accordingly to the given instructions. In other systems, arrows on a dashboard, for example, can be decoded, such as by a wearable computer, e.g., GOOGLE GLASS. In one embodiment, an arrow is provided by the wearable computer on a user display. In other embodiments, noise for an activated directional signal can be detected and evaluated.

It is understood that the audio cues can be provided and customized in a variety of ways. For example, for a 90 degree turn, the system can decrease the volume of the opposite speaker by a selected amount, e.g., 75%. For a less aggressive turn, the volume of the opposite speaker can be decreased by say 50%. Also, the spoken direction can be positioned dynamically within the three-dimensional space. Further, phase cues can be used along with volume. That is, certain audio-centered techniques can be used to spatially position audio feedback, such as TTS prompts, etc., with reference to where the destination is in the driver's physical environment. In other words, the driver's sound field is matched to a geographic position of the destination. This can be achieved, for example, by as adjusting volume, panning, and/or phase shifting the audio feedback. In other embodiments, three-dimensional space is used for direction positioning.

By providing visual and/or spatial cues to a driver for route instructions, a quicker and more reliable response to GPS instructions is achieved. In addition, providing user feedback on route adherence can increase user confidence in drivers having direction confusion and enhance road safety for everyone.

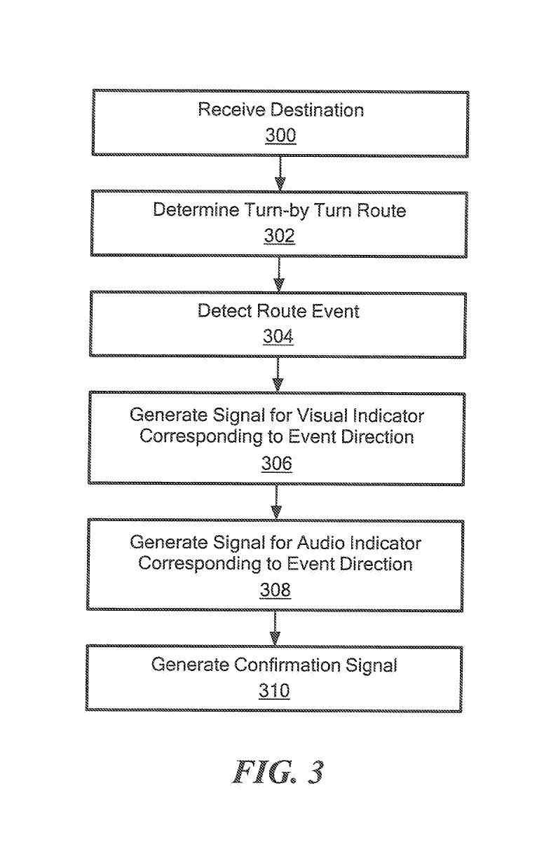

FIG. 3 shows an illustrative sequence of steps for generating directional cue signals for a GPS navigation system. In step 300, destination information is received from a user and in step 302 a turn-by-turn route is determined to arrive at the destination. In step 304, a first event in the route is detected at a location a selected distance from the event. For example, the event can comprise a left turn. In step 306, a visual cue signal is generated to activate a visual indicator, such as a left arrow, corresponding to the direction of the event. In step 308, an audio cue signal is generated to activate an audio source, such as a left speaker, corresponding to the direction of the event.

In another aspect of the invention, a system provides monitoring of driver visual attention. As is known, distracted driving is a leading cause of motor vehicle accidents. By increasing driver attention to the car and road, road safety is enhanced.

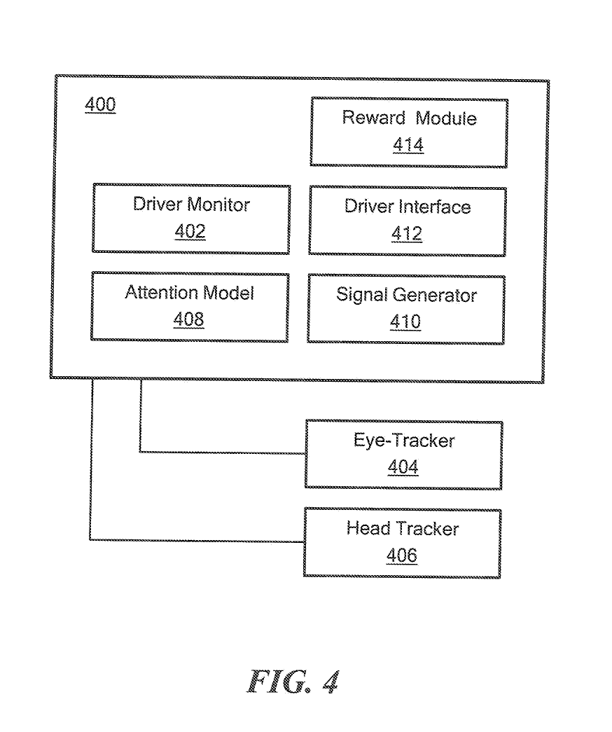

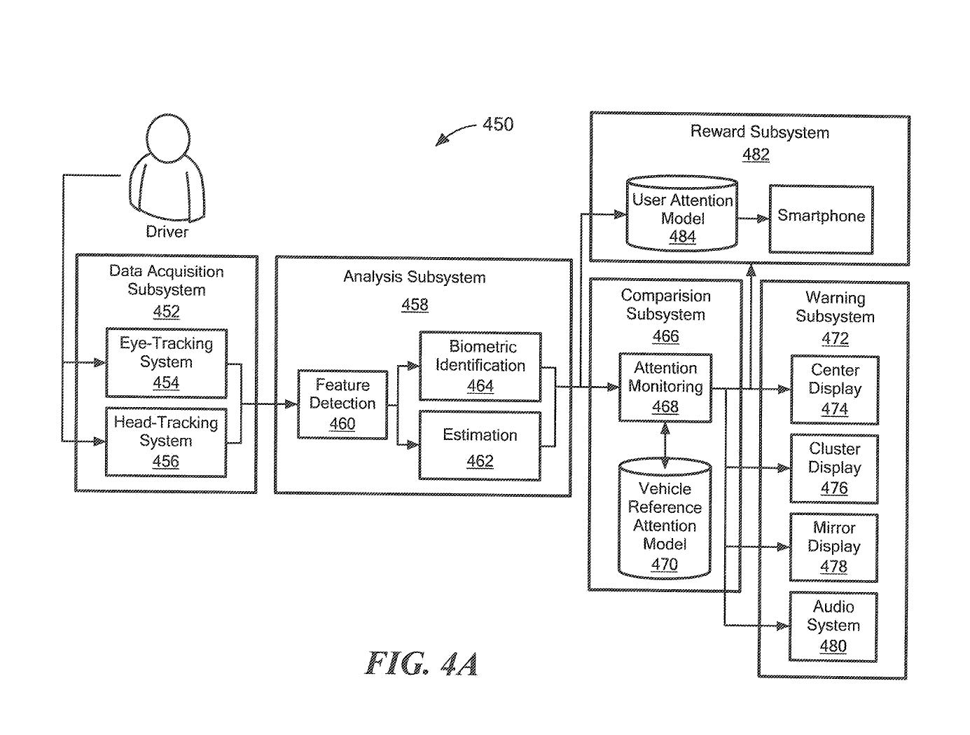

FIG. 4 shows a system 400 for monitoring the visual attentiveness of a driver of a vehicle and generating signals to notify the driver of low attention. The system 400 includes a driver monitor module 402 that can include an eye-tracking system 404 and/or a head-tracking system 406. The eye-tracking system 404 monitors and measures the driver eye gaze direction and provides information to the driver monitor module 402. An attention model module 408 creates a real-time driver attention model based on various parameters, as described more fully below. A signal generator module 410 can compare measured information against reference model 408 and generate warning(s) to the driver. The system 400 can include a driver interface module 412 to enable a user to input preferences, identifying information, navigation information, etc. For example, if a driver recognizes a feeling of being tired, the driver can select a preference for an aggressive level of warning generation. In one embodiment, the driver can select a preferred format of the warnings, such as audio, visual, e.g., flashing LED, seat vibration, etc. In one embodiment, the system 400 includes a reward module 414 to incentivize attentive driving.

The head-tracking system 406 monitors and measures the position of the driver's head and provides information to the driver monitor module 402. In illustrative embodiments, the eye-tracking system 404 and the head-tracking system 406 are located on a vehicle dashboard and use video analysis to monitor driver eye and head information. In embodiments, in addition to eye and head positioning, yawning and other driver behavior is detected. In one embodiment, physiological signals, such as blinking, and speech, respiration rate and heart rate; are monitored It is understood that eye and head tracker systems are well known in the art.

In one embodiment, the attention model 408 includes identifying information and statistical information. Identifying information, which can be computed using facial recognition techniques, is used to select a specific attention model based on the driver identity. Statistical information can include continually updated driver eye gaze direction and head rotation information from the eye and head tracker modules 404, 406.

While driving, the driver attention model 408 is continuously compared against a reference attention model for the specific vehicle being driven, for example. In one embodiment, the reference model defines specific zones of the vehicle. The signal generator module 410 can compare measured information against reference model zones and generate an alert signal, such as an audio warning. For example, if the driver is observed to look in the direction of the model zones for the vehicle at least once within selected time intervals, it can be determined that the driver is paying attention to the road, e.g., driver attentiveness is above one or more thresholds. If it is determined that the driver is not attentive, then the signal generator module 410 can generate an alert signal. In one embodiment, the reference model 408 can include parameters for eye gaze, head rotation angle, gaze duration, and the like. Illustrative parameters include horizontal eye position, horizontal eye velocity, vertical eye position, vertical eye velocity, eye gaze duration, eye gaze angle, eye gaze fixation distance, blink duration, head rotation angle, head rotation velocity, and head position duration.

Illustrative ‘attention zones’ can include specific regions/boundaries of a front windshield, instrumentation cluster, infotainment cluster/center stack, side view mirrors and blind spots, rear view mirror, etc. It is understood that a wide variety of information can be used to determine driver attentiveness. For example, consistent vehicle acceleration and deceleration on a highway for example, can indicate lack of attentiveness based on vehicle speedometer and roadway information. The system can also determine driver attentiveness based upon the duration of time spent looking at the front windshield. Based on the continuous analysis, the signal generator module 402 can measure the amount of time spent looking away from the front windshield at any given moment and generate alerts as appropriate.

It is understood that a wide variety of alerts and signals can be generated by the signal generator 410 upon detecting that driver attentiveness has fallen below at least one threshold. For example, the signal generator 410/driver interface 412, upon detecting excessive yawning (e.g., more than N yawns in X minutes) can trigger a ‘chat bot’ that provides an audible list of options to the user, such as an upbeat music channel, nearest exit with lodging, nearest rest area, nearest location having coffee available, or other location-aware options.

The reward module 414 can provide a range of rewards to incentivize and reinforce positive driver behavior with respect to superior attentiveness. In one embodiment, the reward module 414 can instruct the driver interface 412 to generate a text-to-speech (TTS) message for the driver, such as ‘thank you for your attentiveness to the road.” In another embodiment, the reward module 414 can store driver behavior so that rewards in the form of discount coupons can be generated, such as auto insurance discounts.

FIG. 4A shows further detail for a system 450 for monitoring the visual attentiveness of a driver. A data acquisition system 452 includes an eye-tracking system 454 and a head-tracking system 456. An analysis system 458 includes a feature detection module 460 that receives the attentiveness information and outputs information to an estimation module 462 and a biometric information module 464, which can include facial recognition, for example, to identify a driver or confirm driver identity.

A comparison module 466 includes an attention monitoring module 468 to compare the acquired information against a vehicle reference attention model 470. In one embodiment, the vehicle reference attention model 470 includes mapping line of sight coordinates (x,y,z) to vehicle regions, e.g., front windshield, and mapping vehicle regions to time limits, e.g., three seconds maximum gaze time for center display. It is understood that the comparisons can include additional parameters, such as blink duration, yawn frequency, and the like, to meet the needs of a particular application.

A warning system 472 can generate a variety of warnings in a range of formats to the user. In one embodiment, warning information can be generated in one or more of a center display 474, a cluster display 476, a mirror display 478, and an audio system 480.

A reward system 482 can receive the output of the analysis subsystem 458 and the comparison subsystem 466 and store the user information in a user attention model database 484. In one embodiment, the user attention model database can generate rewards that can be conveyed to a smartphone, for example. The user attention model database can be updated in real time and can be analyzed at a later time.

The database can be made available to the user, as well as third parties for analysis. This is facilitated by conveying the database from the system (FIG. 4) to a smartphone, for example, or server at an entity, such as an insurance company.

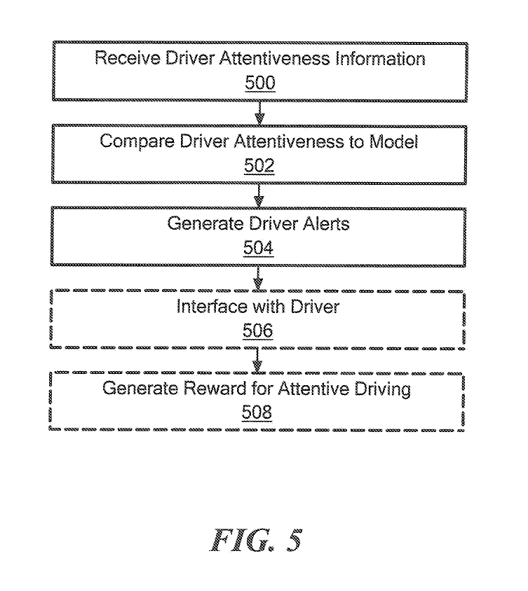

FIG. 5 shows an exemplary sequence of steps for monitoring driver attentiveness. In step 500, driver attentiveness is received, such as eye and head tracking information. In step 502, the driver attentiveness information can be compared with a reference model, which can include, for example, reference zones for a vehicle that should be monitored by a driver. In step 504, if a driver is below one or more attentiveness thresholds, an alert can be generated to modify driver behavior and increase attentiveness. In optional step 506, the system can interface with the driver, such as by offering a list of options including music, exits, location-aware places, etc. In optional step 508, rewards can be generated for the driver for attentive driving. Illustrative rewards include audible messages and discounts.

Embodiments of a driver attentiveness system enable driver attention models to be created and updated for various drivers and vehicles. Driver attentiveness can be measured and compared to the models to enable the generation of alerts to the driver. Attentive driving can be rewarded by providing positive feedback, discounts or other incentives.

In another aspect of the invention, methods and apparatus for low-distraction mode driving are provided. While drivers often desire to remain connected to electronic devices while driving, a low-distraction mode in a vehicle can enhance overall road safety.

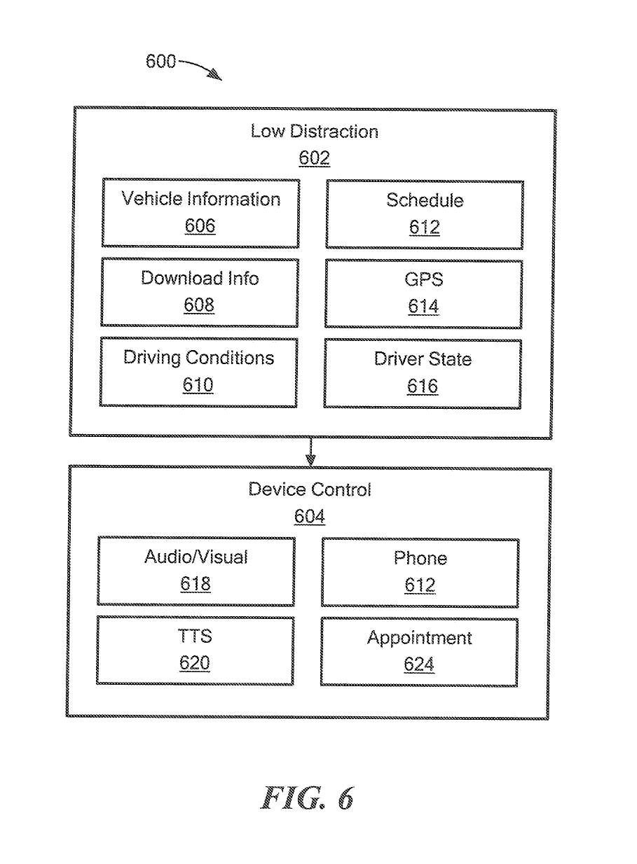

FIG. 6 shows a system 600 having a low-distraction module 602 having a series of modules to obtain information to detect potential distractions and a device control module 604 to control devices based on the distraction level of the user. Driver attentiveness based on the detected information can be used to trigger low distraction mode.

In the illustrated embodiment, the low distraction module 602 includes a vehicle sensor module 606 to obtain vehicle sensor information, such as rain, speed, road bumpiness, ambient light level, etc. Rain at night, for example, may trigger low distraction mode. A download information module 608 obtains information that can be downloaded or otherwise received from a remote source. For example, the download module 608 can obtain traffic information, such as traffic jams, road construction, accidents, etc. A driving condition module 610 receives information on driving conditions, which can include, for example, weather reports predicting rain, new moon, or other information impacting driving conditions. Such information can trigger low distraction mode, for example.

A schedule module 612, in conjunction with a GPS module 614, can access a user calendar, obtain a meeting location, and determine whether the driver will be on time for the meeting. For example, if local time is 1:45 pm with a meeting scheduled for 2 pm, and the GPS indicates that the meeting location is forty minutes away, the schedule module 612 can determine that the driver will not be on time for the meeting. In this situation, the schedule module 612 can generate an audible message for the user. As described below, this situation can trigger low distraction mode.

A driver state module 616 can detect the emotional state of a driver. In one embodiment, a speech recognition system can analyze user pitch, speaking rate, and other speech characteristics to determine that the user is angry or frustrated, for example. In addition, visual cues from the user can be analyzed to determine user emotional state. Upon detecting certain emotional states, a low distraction mode can be triggered, as described more fully below. It is understood that various components of the system, such as the driver state module, can be implemented on a remote server, for example.

In general, once triggered, in low distraction mode the device control module 604 modifies device performance and/or interaction with the user in order to lessen distractions to the user. In the illustrated embodiment, certain devices may be adjusted or turned off by an audio/visual module 618. For example, the audio/visual module 6618 can turn down the amplitude of music and/or radio and/or turn off visual displays not relevant to driving. Note that a GPS display would generally not be turned off. In one embodiment, when the GPS is about to give route instructions the audio/visual module 618 can turn off all other audio, play GPS instructions, and turn the audio back on.

A TTS (text-to-speech) module 620 can control certain operations to minimize user distraction in low distraction mode. For example, TTS SMS, email, and phone operations can be adapted, such as by making TTS sentences shorter (e.g., fewer words, less verbose), using so-called “earcons,” symbolic (non speech) sounds, and/or speaking more quickly.

A phone module 622 can control user interaction with the user's mobile device. For example, when there is an incoming call or IM, the phone module 622 can respond automatically, (with or without informing the driver depending upon the level of distraction detected). In one embodiment, a selected outgoing message can be generated, such as “I'm pretty busy driving now, it would be better if we spoke later.” The phone module 622 can include an exception list so that callers pre-identified by the user will be able to reach the driver. The level of distraction, as discussed above, can be used to determine how devices can interact with the driver. A variety of user-configurable options will be readily apparent to one of ordinary skill in the art. For example, the phone module 622 can play the incoming call for the user and allow the user to answer the call. In addition, the caller is sent to voicemail and optionally played back when out of low distraction mode or arrival. Further, an offer can be made to call the person back.

It is understood a number of distraction levels can be provided depending upon the detected information. For example, a heavy rainstorm at night may correspond to highest level of user distraction. A detection of a frustrated user may correspond to the lowest level of distraction. The different levels of distraction can be used to adjust devices accordingly.

An appointment module 624, in conjunction with the schedule module 612 and GPS module 614, can generate messages to meeting attendees, for example, upon determining that the driver will be late to the meeting. For example, upon determining that the driver will be late to a scheduled meeting, the appointment module 624 generates an email and/or SMS message to the meeting host and/or attendees. The driver can be queried as to whether the message(s) should be sent. In one embodiment, an offer to reschedule can be generated.

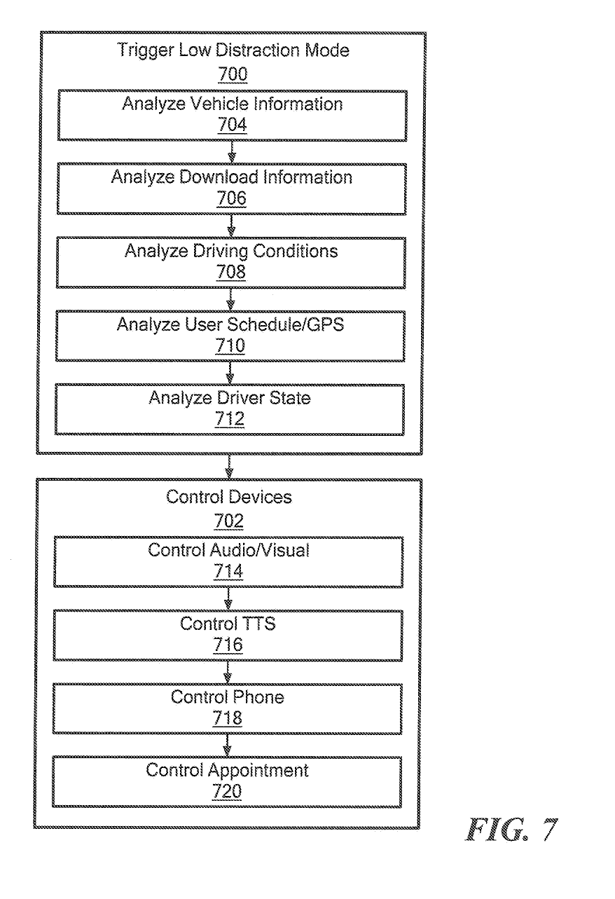

FIG. 7 shows an illustrative sequence of steps for entering low distraction mode and controlling devices while in low distraction mode. In step 700, various information is analyzed to determine whether low distraction mode should be entered and in step 702, once in low distraction mode, various devices are controlled to mitigate user distraction.

In step 704, vehicle information, such as speed, is analyzed and in step 706, downloaded information, such as traffic, is analyzed. In step 708, driving conditions, such as rain, are analyzed. In step 710, a user schedule is analyzed in combination with a GPS to determine whether a user will be late for a meeting based on the amount of time until the destination is reached and the meeting start time. If the user will not make the meeting on time, the low distraction mode can be entered.

In step 712, a user state can be analyzed to determine if the low-distraction mode should be entered. For example, if a speech recognition system detects that the user is angry, the low distraction mode may be entered.

Once the low distraction mode is entered, devices can be controlled to reduce user distraction in step 702. In step 714, audio/visual operation of devices can be modified to reduce distraction, such as by turning displays off. In step 716, TTS can be adjusted to shorten sentences. In step 718, phone interaction can be modified to reduce distraction, such as by responding automatically with or without user knowledge. In step 720, information about user appointments can be used to generate messages to a meeting host or attendees in the event that the user will be late to the meeting.

In another aspect of the invention, methods and apparatus are provided for automatic monitoring and reporting of roadway hazards and information. Drivers are often uninformed of roadway hazards prior to reaching the hazard, which results in less time for the driver to take the necessary precautions (e.g., adjust speed, change lanes, take alternate route, etc. . . . ) to mitigate the impact of the hazard. Drivers who are unfamiliar with an area may overlook road regulations and warnings (e.g., school zones, construction zones, speed limits, children at play, wildlife crossings), resulting in traffic violations or accidents.

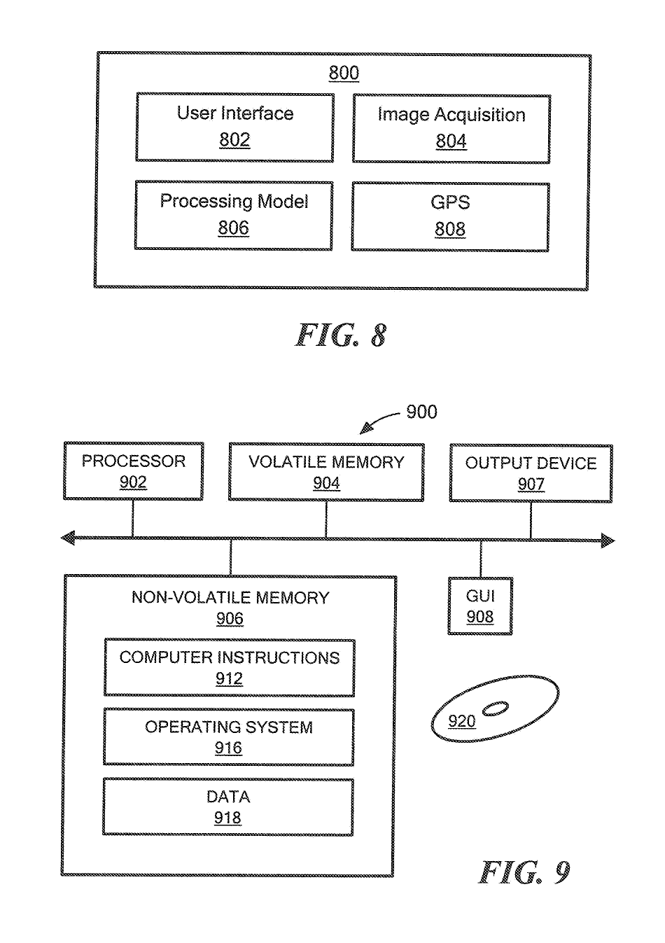

FIG. 8 shows a navigation system 800 having a user interface 802 to inform a driver of roadway hazards, traffic regulations and warnings, which can be static or dynamic, and an image acquisition system 804 to capture roadway signage and a processing module 806 to process and recognize the captured signage information. A GPS module 808 can incorporate warnings etc., into routes and route offerings for events downloaded from a traffic site, for example.

Illustrative signage that can be captured by the image acquisition system 804 includes dynamic roadway hazards, such as accidents, inclement weather, and construction work zones, static traffic regulations and warnings, such as speed limits, general speed limits, school speed limit zones, construction speed limit zones, and warnings, such as sharp curves, bike lanes, railroad crossings, children at play, handicapped areas, wildlife crossings, and traffic cameras. Suitable image acquisition systems 804 are well known in the art to acquire images using videographic equipment. For example, image processing of acquired images and symbols are well known and license plate readers, for example, are ubiquitous on U.S. highway systems.

In one embodiment, the processing module 806 provides decoded signage information after which the user interface 802 triggers a contextually-appropriate speech prompt that informs the driver of the upcoming incident or warning ahead of time. In illustrative embodiments, the user interface 802 initiates a dialogue in certain conditions. Prompts are triggered based on the usage context, the navigation system mode of operation, and/or the type of incident/warning.

The system 800 can include a range of user-configurable options. For example, a user may prefer audio prompts while another user may prefer video prompts. The user can be given the ability to enable or disable prompts by type, such as disabling prompts corresponding to wildlife crossing warnings.

In one embodiment, the GPS module 806 can receive destination information from a user and plan a route to the destination. The user interface module 802 in combination with the GPS module 806 can inform the user of hazards along planned/current route, inform the user of which lane to merge to, inform the user of the time delay, and the like.

In addition, as the GPS module 806 gives route guidance to the user for a destination, the user interface module 802 can offer alternate route(s) to the destination that avoid hazard(s). In the case of a static traffic regulation/warning, the user interface 802 can announce to the user the regulation/warning.

In one embodiment, for dynamic roadway hazards, prompts are triggered based on expected delay relative to normal traffic conditions. The expected delay is calculated based on the vehicle current location from the hazard, the time of the hazard (in the case of an accident or inclement weather), and current traffic conditions on the impacted road. For static traffic regulations or warnings, prompts are triggered prior to, or as the driver passes the physical sign.

FIG. 9 shows an exemplary computer 900 that can perform at least part of the processing described herein. The computer 900 includes a processor 902, a volatile memory 904, a non-volatile memory 906 (e.g., hard disk), an output device 907 and a graphical user interface (GUI) 908 (e.g., a touchscreen display, for example). The non-volatile memory 906 stores computer instructions 912, an operating system 916 and data 918. In one example, the computer instructions 912 are executed by the processor 902 out of volatile memory 904. In one embodiment, an article 920 comprises non-transitory computer-readable instructions.

Processing may be implemented in hardware, software, or a combination of the two. Processing may be implemented in computer programs executed on programmable computers/machines that each includes a processor, a storage medium or other article of manufacture that is readable by the processor (including volatile and non-volatile memory and/or storage elements), at least one input device, and one or more output devices. Program code may be applied to data entered using an input device to perform processing and to generate output information.

The system can perform processing, at least in part, via a computer program product, (e.g., in a machine-readable storage device), for execution by, or to control the operation of, data processing apparatus (e.g., a programmable processor, a computer, or multiple computers). Each such program may be implemented in a high level procedural or object-oriented programming language to communicate with a computer system. However, the programs may be implemented in assembly or machine language. The language may be a compiled or an interpreted language and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network. A computer program may be stored on a storage medium or device (e.g., CD-ROM, hard disk, or magnetic diskette) that is readable by a general or special purpose programmable computer for configuring and operating the computer when the storage medium or device is read by the computer. Processing may also be implemented as a machine-readable storage medium, configured with a computer program, where upon execution, instructions in the computer program cause the computer to operate.

Processing may be performed by one or more programmable processors executing one or more computer programs to perform the functions of the system. All or part of the system may be implemented as, special purpose logic circuitry (e.g., an FPGA (field programmable gate array) and/or an ASIC (application-specific integrated circuit)).

Having described exemplary embodiments of the invention, it will now become apparent to one of ordinary skill in the art that other embodiments incorporating their concepts may also be used. The embodiments contained herein should not be limited to disclosed embodiments but rather should be limited only by the spirit and scope of the appended claims. All publications and references cited herein are expressly incorporated herein by reference in their entirety.

What is claimed is:

1. A method, comprising:
generating, for a GPS system-directed route, a visual cue signal to activate a visual indicator at a location in a vehicle passenger compartment corresponding to a direction of an upcoming event in the route; and
generating an audio signal to activate a sound source at a location in the vehicle passenger compartment corresponding to the direction of the upcoming event for providing spatial information to a user.

2. The method according to claim 1, further including generating a validation signal to activate a confirmation indicator upon receiving information that the user has navigated the event in accordance with the route.

3. The method according to claim 1, wherein the GPS system is configured for a vehicle and for providing route instructions to the user driving the vehicle.

4. The method according to claim 1, wherein the visual indicator comprises an arrow.

5. The method according to claim 1, wherein the visual cue signal is adapted to activate the visual indicator located on a left side of the vehicle passenger compartment when the upcoming event comprises a left turn.

6. The method according to claim 1, wherein the audio signal is adapted to activate the audio source on a left side of the vehicle passenger compartment when the upcoming event comprises a left turn.

7. The method according to claim 6, wherein the audio source comprises a loudspeaker and the audio signal comprises a signal to generate a particular sound from the loudspeaker.

8. The method according to claim 7, wherein the audio signal comprises a spoken instruction to turn left and the loudspeaker is located on a left side of the vehicle passenger compartment.

9. The method according to claim 1, wherein the validation signal is adapted to activate the confirmation indicator located on a left side of the vehicle passenger compartment when the upcoming event comprises a left turn.

10. The method according to claim 1, wherein the validation signal is adapted to activate a visual display.

11. The method according to claim 1, wherein the validation signal is adapted to activate a sound generator.

12. The method according to claim 1, further including generating a warning signal if the event is not navigated in accordance with the route.

13. An article, comprising:
a non-transitory computer-readable medium having stored instructions that enable a machine to:
generate, for a GPS system-directed route, a visual cue signal to activate a visual indicator at a location in a vehicle passenger compartment corresponding to a direction of an upcoming event in the route; and
generate an audio signal to activate a sound source at a location in the vehicle passenger compartment corresponding to the direction of the upcoming event for providing spatial information to a user.

14. The article according to claim 13, further including instructions to generate a validation signal to activate a confirmation indicator upon receiving information that the user has navigated the event in accordance with the route.

15. The article according to claim 13, wherein the visual cue signal is adapted to activate the visual indicator located on a left side of the vehicle passenger compartment when the upcoming event comprises a left turn.

16. The article according to claim 13, wherein the audio signal is adapted to activate the audio source on a left side of the vehicle passenger compartment when the upcoming event comprises a left turn.

17. The article according to claim 16, wherein the audio source comprises a loudspeaker and the audio signal comprises a signal to generate a particular sound from the loudspeaker.

18. A system, comprising:
a memory and a processor configured to:
generate, for a GPS system-directed route, a visual cue signal to activate a visual indicator at a location in a vehicle passenger compartment corresponding to a direction of an upcoming event in the route; and
generate an audio signal to activate a sound source at a location in the vehicle passenger compartment corresponding to the direction of the upcoming event for providing spatial information to a user.

19. The system according to claim 18, wherein the processor and the memory are further configured to generate a validation signal to activate a confirmation indicator upon receiving information that the user has navigated the event in accordance with the route.

20. The system according to claim 18, wherein the visual cue signal is configured to activate the visual indicator located on a left side of the vehicle passenger compartment when the upcoming event comprises a left turn.
